(19) United States
(12) Patent Application Publication
(10) Pub. No.: US 2008/0232996 A1
(43) Pub. Date: Sep. 25, 2008

(54) Method for Fabricating Parts by PIM or MICROPIM

(75) Inventors: LUC FEDERZONI, BOURGOIN-JALLIEU (FR); PASCAL REVIRAND, SAINT EGREVE (FR)

Correspondence Address: CANTOR COLBURN, LLP, 20 Church Street, 22nd Floor, Hartford, CT, 06103, US

(73) Assignee: COMMISSARIAT A L'ENERGIE ATOMIQUE, PARIS (FR)

(21) Appl. No.: 12/037,675

(22) Filed: Feb. 26, 2008

(30) Foreign Application Priority Data
Mar. 22, 2007 (FR) 07 53985

(51) Int. Cl. B22F 1/00; B22F 3/12; B28B 3/00

(52) U.S. Cl. 419/36; 264/109; 264/39; 977/776; 977/777

(57) ABSTRACT

“The present invention relates to a method for fabricating parts by an injection molding technique including preparing a feedstock—having at least one powder mixed with a polymer binder solubilized in a solvent, injecting the feedstock into the mold under pressure, debinding, and sintering where the feedstock is maintained at a temperature above a solvent vaporization temperature during the pressing.”

### TECHNICAL FIELD OF THE INVENTION

The present invention deals with a novel method for fabricating objects by techniques called “powder injection molding” (PIM) or “micro powder injection molding” (microPIM).

Such a method serves to obtain parts having undergone a minimum shrinkage in sintering, and therefore having high geometric repeatabilities. It also serves for fabricating bulky parts.

The method according to the invention is particularly suitable for the case in which the powders of the feedstock are nanopowders of ceramics or of metal alloys.

### BRIEF DESCRIPTION OF RELATED ART

The powder injection molding technique (PIM, or microPIM for ultrafine powders) is commonly used for producing various objects.

In such a method, the first step consists in obtaining a feedstock suitable for the intended application.

The feedstock consists of a mixture of organic matter (or polymer binder) and inorganic powders (metal or ceramic).

The feedstock is then injected like a thermoplastic.

The part is then stripped of binder and then sintered.

However, the PIM processes currently applied have limits, and even drawbacks.

A first drawback concerns a lack of accuracy of the parts fabricated by such a method, associated with the fact that these parts undergo high shrinkage during the sintering step. In fact, this step serves to convert a part having a porosity of about 40% to one with virtually zero porosity, by densifying the powder. This step therefore causes a volume shrinkage of about 40%.

In most cases, this shrinkage is not perfectly uniform or isotropic, making it difficult to comply with very strict geometric dimensions. It is accordingly observed that the dispersion of a geometric dimension on a sintered part is, in the best of cases, 0.5% of a given geometric dimension. For example, a wall having a thickness of 2 mm is liable to have a thickness dispersion of 10 microns.

Moreover, sintering can cause substantial distortions of the part, possibly leading to its cracking during sintering.

In consequence, PIM and microPIM processes cannot be used where geometric accuracy of the parts is too demanding.

Solutions have been investigated to overcome this problem. Thus, document U.S. Pat. No. 4,113,480 describes a type of feedstock composition designed to minimize sintering shrinkage. This type of composition serves to obtain a post-debinding density close to the tamped density of the powder (about 65% of the theoretical density). In this case, the volume shrinkage during sintering is limited to 35%.

This document mentions the idea of heating the mold to the highest possible temperature, in order to lead to extraction by separation of the polymers and of the water in liquid form. This extraction stops when the part has sufficient mechanical strength to be extracted from the mold. The debinding of the water continues outside the press, usually leading to fracturing of the part.

Furthermore, this solution is only suitable for coarse powders, which are not likely to be entrained by the liquid dehydration.

It has also been considered to improve the uniformity of the feedstocks to obtain the most uniform possible sintering shrinkage.

For example, document EP 0 468 467 presents a powder/polymer feedstock composition serving to improve the uniformity of the feedstock by controlling the oxygen content and by preparing a feedstock having a uniform composition.

A second limit of current PIM processes concerns the size of the fabricated parts. It is conventionally considered that the parts fabricated by PIM cannot exceed 2 cm. This limit is due to the difficulty associated with debinding. This is because debinding consists in extracting organic matter from the core of the material. For very large volume parts, the parts crack or explode during the debinding.

Another difficulty consists in applying the method to fine, even nanometric powders.

In fact, it has been observed that the use of ultrafine powders increases the viscosity of the feedstocks at iso-filler-content. This is explained by the increase in the specific surface area of the powders, making the surface effects predominate in the Theological behavior of the feedstocks.

Thus, the developments under way on microPIM are faced with this problem. At present, the only solutions developed consist in replacing the conventional feedstocks used in PIM by feedstocks based on very low viscosity wax. However, these solutions have their limits, and it appears impossible to obtain feedstocks based on nanopowders. In fact, the utilization of this method for fabricating microcomponents (very fine details), components with a very good surface texture (low Ra), or simply components with very good mechanical properties (nanomaterials) appears to be extremely promising.

An obvious need therefore exists to develop improved methods for fabricating parts by PIM or microPIM.

### BRIEF SUMMARY OF THE INVENTION

The present invention is therefore related to a method for fabricating parts by the injection molding technique, in which the succession of steps carried out serves to avoid the conventional pitfalls of this technique.

Thus, the method according to the invention serves to obtain parts, without any limitation of size or accuracy, particularly when made from nanopowders.

Conventionally, the method according to the invention comprises the following essential steps:
preparation of a feedstock;
injection of the feedstock into the mold under pressure;
debinding;
sintering.

According to the invention and in a characteristic manner, the feedstock comprises at least one powder mixed with a polymer binder solubilized in a solvent, said mixture being maintained at a temperature above the solvent vaporization temperature during the pressing.

Without being bound by any theory whatsoever, it is assumed that the injection of the feedstock under pressure in a very hot mold causes the in situ extraction of a significant share of the polymer and of its solvent near the surface, as vapor. Thus, the solvent evaporates and leaves the polymer at the surface of the part. This process saves considerable time compared to the methods of the prior art which are liquid methods.

It should be observed that, according to the invention, the solvent is completely removed from the part, before its extraction. Thus, an additional step of heating of the part (to a temperature obviously higher than the solvent vaporization temperature but much lower than that employed in the debinding step), after its extraction from the mold, is unnecessary.

As already stated, the essential step of the method according to the invention consists, after injection, in maintaining the feedstock under pressure and at a temperature higher than the solvent vaporization temperature. During this operation, the solvent escapes from the part and evaporates, entraining the polymer which migrates toward the surface of the sample. In separating from the solvent, the polymer sets, producing a solid shell which maintains the powder by said plastic shell.

By maintaining the pressure, the part continues to densify, the void left by the migration of the solvent and polymer being offset by the densification, that is, the aggregation of the powder grains. The latter aspect is vitally important for feedstocks prepared with nanopowders. This is because, despite the initial filler content which may be low (about 30 to 40%), the method according to the invention serves to reach high densities of brown parts, after debinding.

Advantageously, the method according to the invention is therefore implemented on feedstocks containing at least one nanopowder. Advantageously, nanopowder means a powder whereof the component particles are smaller than 100 nm.

It should be noted that the subsequent step of drying of the part after ejection is particularly favorable in the case of nanopowders. In fact, it has been observed that during the debinding of a conventional method, the moldings made from nanopowders disintegrate. It is assumed that, due to the very low volume of the nanopowder grains, it is the excessively high percentage of polymer which causes this problem. In fact, the method according to the invention serves to eliminate this problem.

In a first step, a feedstock is therefore prepared. This involves blending at least one powder or nanopowder, advantageously of the ceramic or metal type, a solvent, and a polymer soluble in the solvent.

Until injection, such a feedstock can be stored in a freezer where it solidifies.

Preferably, the solvent is an aqueous solvent, even more preferably water. A suitable polymer, soluble in water at ambient temperature, is carboxymethyl cellulose (CMC).

The polymer may be present in a proportion of 3% to 50% of the total volume of the feedstock.

The feedstock is then injected into a conventional press, for example a 25 tonne press. A minimum pressure of about 140 bar is conventionally applied during about 30 seconds.

The result is better with a higher pressure and a longer duration.

In the case in which the feedstock solvent is water, the mold is heated to above 100° C., for example to 110° C.

During said heating, the solvent evaporates and escapes through the clearances of the device. It is then important to maintain the initial pressure in the mold. For this purpose, a controlled-pressure press can be used, for example, or a calibrated spring placed behind the mold, which maintains the feedstock at the desired pressure during the drying phase.

Advantageously, the mold is then cooled, for example to 80° C. for a few hours. This serves to freeze the polymer and hardens the shell of the part. The part can then be easily ejected and handled.

The conventional operations of thermal debinding and presintering are then carried out, for example in air at 1100° C. This debinding step serves to strip the molding of the polymer film created on its surface. During the same thermal debinding operation, the presintering serves to predensify the part and facilitate its handling during subsequent operations.

The final step is the sintering step, carried out for example at a temperature of 1700° C.

Between debinding and sintering, an additional step of removal of any waste may be provided, by washing, particularly by dipping the part in water.

It appears that the present invention simultaneously has all the following advantages. The parts fabrication method, as described, serves to:
fabricate parts with a maximum green density, corresponding to the dry powder pressed to the press holding pressure;
produce parts with minimized shrinkage. In fact, because of the high densities obtained after ejection, the sintering shrinkage is thereby minimized;
limit the thermal debinding operation to its simplest expression, and regardless of the size of the part to be produced. In fact, the debinding of the part consists simply in removing the polymer skin;
ensure low body pollution of the powder (pollution with carbon, oxygen in particular), thanks to the migration of the polymer to the surface;
fabricate bulky parts. Most of the body debinding is completed during the pressure holding operation in the press, thereby eliminating the risk of explosion/cracking of the part;
fabricate parts from feedstocks of powders, or nanopowders, that is fine powders, which are generally unsuitable for PIM (very low cost powders with a non-spherical morphology).

### BRIEF DESCRIPTION OF THE DRAWING AND DETAILED DESCRIPTION OF THE INVENTION

The following exemplary embodiments, in conjunction with the appended figure, are intended to illustrate the invention but are not at all limiting.

FIG. 1 shows the various steps of the fabrication method according to the invention, based on the injection molding technique.

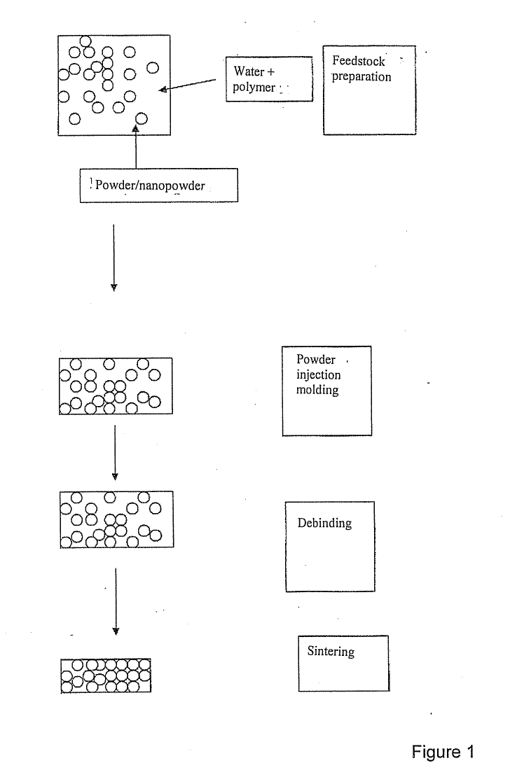

A ceramic based feedstock is prepared. This comprises two batches of identical alumina powders with a grain size distribution, one centered on 150 nm, the other on 300 nm.

The organic part is composed of 8% CMC, acting as polymer, and the remainder is water. The total volumetric filler content is 70%.

After having been solidified in a freezer, the feedstock is injected into a 25 tonne press delivering a pressure of 140 bar.

The cylinder is injected into a mold heated to 110° C. A pressure of 140 bar is maintained for 30 seconds.

The mold is then cooled to 80° C. and the part is ejected.

Due to the maintenance of the pressure during the heating step, the green density (post-injection density) is close to 75%, or 5 percentage points more than the filler content of the feedstock.

The part is then stripped of binder and presintered at 1100° C. in air.

The part is dipped in water at 80° C. for five hours, then sintered at 1700° C.

2. Production of an Alumina Part from Nanopowders

A ceramic based feedstock is prepared, this time composed of a batch of powder with a grain size distribution centered on 50 nm (nanopowder). The total filler content is 40%, which, in this technical field, is considered to be too low to produce sound parts after the debinding cycle.

After having been solidified in a freezer, the feedstock is injected into a 25 tonne press.

The cylinder is injected into a mold heated to 110° C. A pressure of 140 bar is maintained for 30 seconds.

The mold is then cooled to 80° C. and the part is ejected.

Due to the maintenance of the pressure, the green density is close to 60%, or 20 percentage points more than the filler content of the feedstock.

The part is stripped of binder and presintered at 1100° C. in air.

The part is dipped in water at 80° C. for 5 hours, then sintered at 1700° C. The final part appears to be sound.

1. A method for fabricating parts by an injection molding technique comprising:
preparing a feedstock—comprising at least one powder mixed with a polymer binder solubilized in a solvent;
injecting the feedstock into the mold under pressure;
debinding;
sintering, and
wherein the feedstock is maintained at a temperature above a solvent vaporization temperature during the pressing.

2. The parts fabrication method as claimed in claim 1, wherein during evaporation of the solvent, an initial pressure in the mold is maintained.

3. The parts fabrication method as claimed in claim 1, wherein the feedstock contains at least one nanopowder, of which particles are smaller than 100 nm.

4. The parts fabrication method as claimed in claim 1, wherein the solvent is an aqueous solvent.

5. The parts fabrication method as claimed in claim 1, wherein the polymer binder is carboxymethyl cellulose (CMC).

6. The parts fabrication method as claimed in claim 1, wherein the polymer binder is present in a proportion of 3% to 50% of the total volume of the feedstock.

7. The parts fabrication method as claimed in claim 1, wherein the mold is cooled for ejecting the part, before the debinding.

8. The parts fabrication method as claimed in claim 1, wherein a washing is carried out before the sintering.
